(19) United States
(12) Patent Application Publication
(10) Pub. No.: US 2004/0006661 A1
(43) Pub. Date: Jan. 8, 2004

(54) Method and device of minimizing the number of LDRQ signal pin of LPC host and LPC host employing the same

(76) Inventors: Chih-Wei Hu, Taipei (TW); Chia-Chun Lien, Taipei (TW); Wallace Huang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/358,291

(22) Filed: Feb. 5, 2003

(30) Foreign Application Priority Data
Jul. 5, 2002 (TW) 091114929

(51) Int. Cl. G06F 13/36

(52) U.S. Cl. 710/113

(57) ABSTRACT

There is provided a method and device of minimizing the number of LDRQ signal pin of a LPC host. At least one of LPC devices requiring to perform DMA transmission or bus master request includes a LDRQ controller serving as a LDRQ control device. The LDRQ control device is connected with a plurality of LPC devices, wherein the LDRQ controller includes a decoding circuit for decoding LDRQ signals into DRQ signals, the DRQ signals are arbitrated by a DRQ control circuit to resolve their priorities, and the DRQ signal having the highest priority is transferred to an encoding circuit to be translated into a LDRQ signal. This LDRQ signal is transferred to either the LDRQ control device of next stage or LDRQ pin of LPC host so that only a single LPC pin is required by LPC host, and thereby the number of LDRQ signal pin of LPC host can be minimized and its manufacturing cost can be lowered.

### FIELD OF THE INVENTION

The present invention is related to a method and device of minimizing the number of LDRQ signal pin of a low pin count bus (LPC bus) host and a LPC host employing the same, and more particularly, the present invention is related to a LPC host that is adapted to handle DMA transmission among the LPC devices connected therewith and other peripheral devices coupled to the LPC bus, or respond to the bus master request issued by LPC devices.

### BACKGROUND OF THE INVENTION

The trend for the contemporary computer system will aim at the integration of multiple I/O interfaces and the incorporation of thin and small electronic components onto a motherboard. In order to advance the I/O interface of computer system to the goal of achieving a high-speed performance and inexpensive budget, Intel Corporation has proffered a new I/O interface that is implemented with less I/O pins, which is well known as low pin count (which is termed “LPC” as an abbreviation) bus. The LPC bus came to be used in place of legacy ISA bus that require 60 pins serving to communicate through address/data lines and control lines with I/O devices, such as keyboard, pointing device and so on. With the advent of the LPC bus, commercially available LPC devices mushroom along with the popularity of LPC interface system implemented in an ordinary computer system. If the LPC device within a computer system requires to carry out DMA (direct memory access) transmission or make bus master request, it will issue encoded DMA/bus master request signal LDRQ to a LPC host. Referring to FIG. 1, which shows the LPC interface system within a computer system according to the prior art. As shown, the LPC host 17 coupled to the LPC bus 10 is connected with three LPC devices, i.e. a first LPC device 11, a second LPC device 12 and a third LPC device 13 that are desired to perform DMA transmission or bus master request operation. In this manner, the LPC host 17 needs three LDRQ signal pins. In greater detail, according to the hardware design of conventional LPC interface system, if a first LPC device 11, a second LPC device 12 and a third LPC device 13 being coupled to the LPC bus 10 are necessary to perform DMA transmission or make bus master request, each of the first LPC device 11, the second LPC device 12 and the third LPC device 13 needs a LDRQ signal line to be connected to the LPC host 17. That is to say, if there are n LPC devices to be connected to the LPC bus 10, the LPC host 17 needs n LDRQ signal pins to process LDRQ signals. In this way, with the increase of LPC devices in the computer system, the LPC host requires more LDRQ signals pins to deal with the LDRQ signals issued by the LPC devices, which indicates the manufacturing cost of the LPC host will raise in the same fashion.

Therefore, what is need is a method and device of minimizing the number of LDRQ signal pin of a LPC host and a LPC host employing the same. In a first aspect of the present invention, the LDRQ signal pin of LPC host 17 can be held minimum, e.g. only a single LDRQ signal pin is required by the LPC host 17. In a second aspect of the present invention, the manufacturing cost of LPC host 17 can be scaled down to address the aforementioned problems.

### SUMMARY OF THE INVENTION

A significant object of the present invention is to provide a method and device of minimizing the number of LDRQ signal pin of a LPC host and a LPC host employing the same. The device used to minimize the number of LDRQ signal pin of LPC host according to the exemplary embodiment of the present invention is directed to a LDRQ controller. At least one of LPC devices coupled to LPC bus that are needed to perform DMA transmission or bus master request operation is provided with a LDRQ controller serving as a LDRQ control device to be coupled to the LPC host. Other LPC devices requiring to perform DMA transmission or bus master request operation as well are coupled with the LDRQ control device, and thereby minimizing the number of LDRQ signal pin of LPC host.

A minor object of the present invention is to provide a method and device of minimizing the number of LDRQ signal pin of a LPC host and a LPC host employing the same, which can enable the LPC host to use a single LDRQ pin to handle DMA transmission among LPC devices and other peripheral devices or respond to the bus master request issued by LPC devices.

The present invention is characterized by the provision of a method and device of minimizing the number of LDRQ signal pin of a LPC host, which utilizes a LDRQ controller to be incorporated within at least one LDRQ control device. The LDRQ control device is connected with a plurality of LPC devices, and the LPC control device is coupled to a LPC host. The LDRQ controller includes a decoding circuit for decoding LDRQ signals into DRQ signals, a DRQ control circuit used to have a priority arbitration process with received DRQ signals and DRQ signal issued by oneself, an encoding circuit for translating received DRQ signals into LDRQ signals and transferring the LDRQ signals to either a LDRQ control device of next stage or a LDRQ signal pin of a low pin count bus host.

Now the foregoing and other features and advantages in connection with the present invention will become apparent through the following descriptions with reference to the accompanying drawings, wherein:

### BRIEF DESCRIPTION OF THE DRAWINGS

FIG. 1 is a block diagram showing the LPC interface system within a computer system according to the prior art;

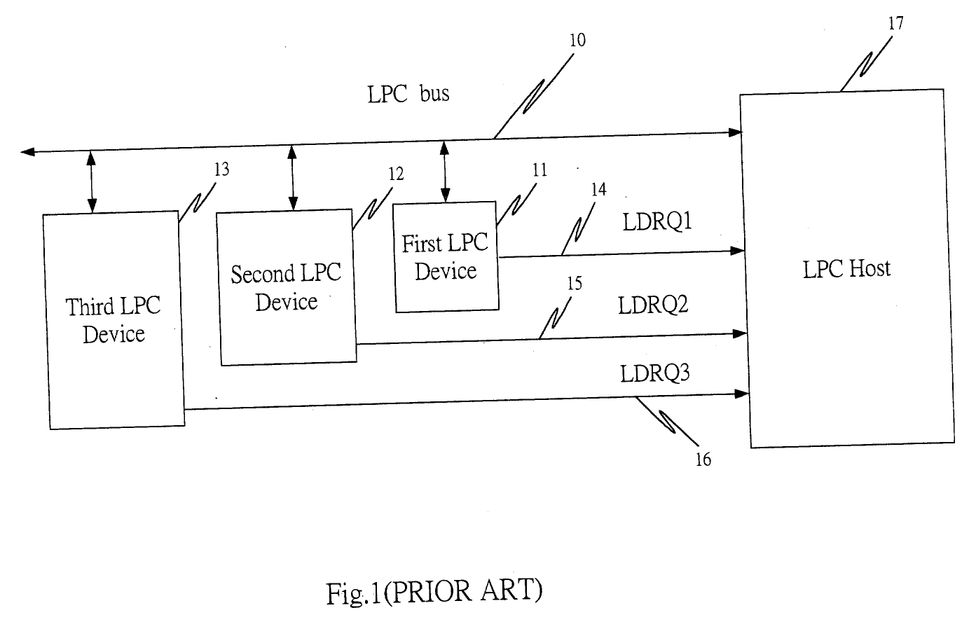

FIG. 2 is a block diagram illustrating a preferred embodiment in accordance with the present invention; and

FIG. 3 is a block diagram illustrating another preferred embodiment in accordance with the present invention.

### DETAILED DESCRIPTION OF THE PREFERRED EMBODIMENT

With the increase of LPC devices in a computer system, the number of LDRQ signal pin of a LPC host will increase as well. Further the manufacturing cost of LPC host will increase as is often the case with multiple LPC devices being present in a computer system. The present invention offers a proposal by providing a method of minimizing the number of LDRQ signal pin in a LPC host to effectively straighten out the deficiency arising from the prior art. A preferred embodiment incorporating the features of the present invention will be enumerated through the following detailed descriptions.

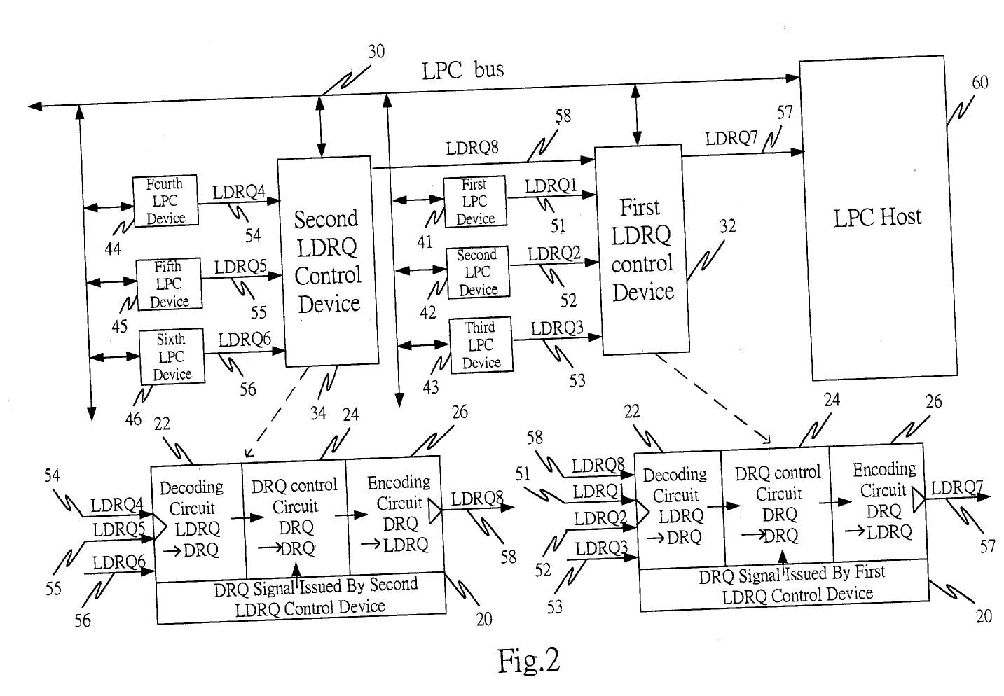

Referring to FIG. 2, which illustrates a block diagram of a preferred embodiment of the present invention. As shown, the LDRQ signal pin of a LPC host 60 coupled to a LPC bus 30 is connected in series with a first LDRQ control device 32 and a second LDRQ control device 34, wherein the first LDRQ control device 32 is connected with three LPC devices, i.e. a first LPC device 41, a second LPC device 42 and a third LPC device 43, the second LDRQ control device 34 is connected with three LPC devices, i.e. a fourth LPC device 44, a fifth LPC device 45 and a sixth LPC device 46. A LPC controller 20 is respectively set within the first LDRQ control device 32 and the second LDRQ control device 34. The LDRQ controller 20 embraces a decoding circuit 22, a DRQ control circuit 24 and an encoding circuit 26.

While the fourth LPC device 44, the fifth LPC device 45 and the sixth LPC device 46 are necessary to accomplish DMA transmission or make bus master request, LDRQ signals are issued and transmitted through a LDRQ4 signal line 54, a LDRQ5 signal line 55 and a LDRQ6 signal line 56 respectively to the LDRQ signal pin of the second LDRQ control device 34, i.e. these LDRQ signals are conveyed from the LPC devices 44, 45 and 46 to the decoding circuit 22 set within the LDRQ controller 20. The decoding circuit 22 is configured to decode the received LDRQ signals into encoded DRQ signals, and then provides DRQ signals for the DRQ control circuit 24. These DRQ signals and the DRQ signal issued by the second LDRQ control device 34 will be arbitrated by the DRQ control circuit 24 to assign priorities to these LPC-based peripheral devices. The arbitration priority for the priority arbitration process will be sequenced according to the relative importance of functionality of the fourth LPC device 44, the fifth LPC device 45, the sixth LPC device 46 and the second LDRQ control device 34. The DRQ signal which obtains the highest priority by virtue of the priority arbitration process will be outputted to the encoding circuit 26 to be processed by encoding mechanism and being translated into LDRQ signal, and the LDRQ signal will be transmitted through a LDRQ8 signal line 58 to the first LDRQ control device 32 being serially connected therewith.

The LDRQ signals issued by the first LPC device 41, second LPC device 42, the third LPC device 43 and the second LDRQ control device 34 are respectively transmitted through LDRQ1 signal line 51, LDRQ2 signal line 52, LDRQ3 signal line 53 and LDRQ8 signal line 58 to the LDRQ controller 20 integrated within the first LDRQ control device 32, and decoded by the decoding circuit 22 into encoded DRQ signals. These DRQ signals and the DRQ signal issued by the first LDRQ control device 32 will be arbitrated by the DRQ control circuit 24 to decide who get the mastership of the LPC bus 30. The arbitration priority for the bus arbitration process will be sequenced according to the relative importance of functionality of the LPC device that obtain the highest priority in the arbitration process executed by the second LDRQ control device 34, the first LPC device 41, the second LPC device 42, the third LPC device 43 and the first LDRQ control device 32. The DRQ signal that obtain the highest priority will be translated into LDRQ signal by the encoding circuit 26, and transmitted through a LDRQ7 signal line to LDRQ signal pin of the LPC host being serially connected therewith.

It can be known from the above discussions that if the fourth LPC device 44, the fifth LPC device 45 and the sixth LPC device 46 are necessary to perform DMA transmission or make bus master request, LDRQ signals are issued and transmitted through a LDRQ4 signal line 54, a LDRQ5 signal line 55 and a LDRQ6 signal line 56 to the decoding circuit 22 of the LPC controller 20 set within the second LDRQ control device 34, and then decoded into DRQ signals. These DRQ signals as well as the DRQ signal issued by the second LDRQ control device 34 are taken to transact the priority arbitration process, while the DRQ signal having the highest priority is processed by the encoding circuit 26 through an encoding mechanism and thus a LDRQ signal is generated. The LDRQ signal generated by the second LDRQ control device 34 and the LDRQ signals respectively issued by the first LPC device 41, the second LPC device 42 and the third LPC device 43 are transferred to the LDRQ controller 20 set within the first LDRQ control device 32, and decoded by the decoding circuit 22 of the LDRQ controller 20 into DRQ signals. In a similar manner, these DRQ signals as well as the DRQ signal issued by the first LDRQ control device 32 participate in the priority arbitration process to decide the priority for getting the mastership of the LPC bus 30. The DRQ signal having the highest priority is encoded by the encoding circuit 26 of the LDRQ controller 20 within the first LDRQ control device 32 into LDRQ signal, and then the produced LDRQ signal is transmitted to the LDRQ signal pin of the LPC host. Obviously, such a configuration for the arrangement of the LPC devices and LPC host according to the present invention will suffice for the minimization of the number of LPC signal pin of the LPC host (reducing from 8 pins to 1 pin).

It is appreciated from the above embodiment that no matter how much LPC devices requiring to perform DMA transmission or make bus master request will be, the number of LDRQ signal pin of LPC host can be minimized by respectively incorporating a LDRQ controller 20 into a first LDRQ control device 32 and a second LDRQ control device 34, and allowing a plurality of LPC devices 51-56 to be either connected with the first LDRQ control device 32 and the second LDRQ control device 34. A priority arbitration process used to refer the bus master requests issued by the LPC devices to arbitration is taken place by the LDRQ controller 20, and the result of priority arbitration is transferred to the LPC host 20. In accordance with such serially-connected LPC interface system architecture of the present invention, only a single LDRQ signal pin is required by the LPC host so that the DMA transmission among LPC devices and other peripheral devices or bus master request operation can be fulfilled. In the case of an increasing popularity of the LPC bus and an increasing number of commercially available LPC devices on the market, the technique of using the serially-connected LPC interface system architecture according to the present invention is capable of keep the number of LDRQ signal pin from overmuch with the addition of LPC devices to the LPC interface system. As a result, only a single LDRQ signal pin is sufficient for the LPC host 60 to couple a plurality of LPC devices together with the LPC bus 30 and accomplish bus master request arbitration operation. This technique can effectively minimize the number of LDRQ signal pin of LPC host, and also the manufacturing cost of the LPC host can be constrained as low as possible.

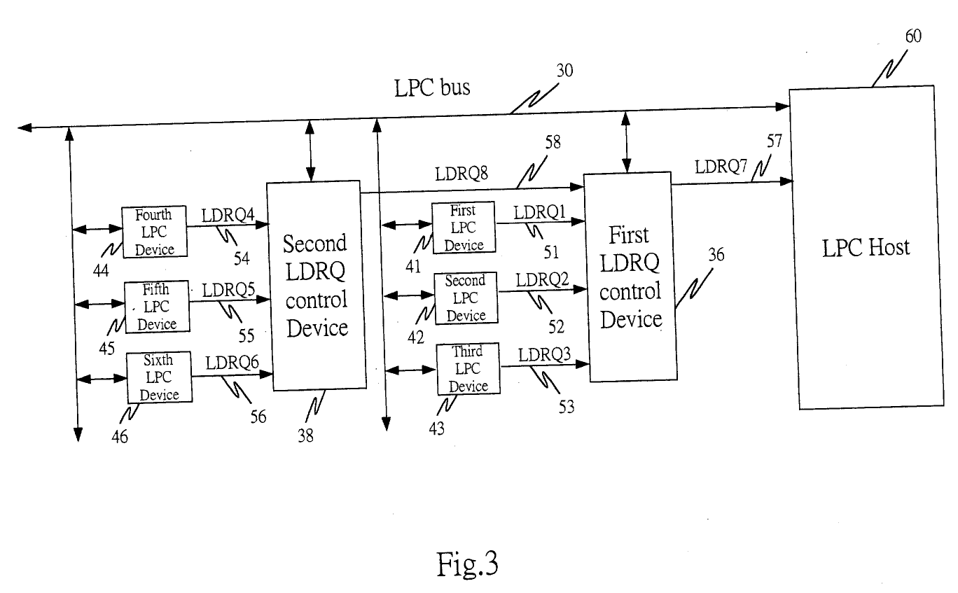

Referring to FIG. 3, which shows another preferred embodiment of the present invention. As shown, the present preferred embodiment is distinct over the foregoing preferred embodiment in terms of the LDRQ controller 20 (please refer to FIG. 2) that the LDRQ controller 20 of FIG. 3 does not need to be incorporated within each LPC device requiring to accomplish DMA transmission or make bus master request. In FIG. 3, a first LDRQ control device 36 and a second LDRQ control device 38 are both directly connected in series with a LPC host 60. The LDRQ signals respectively issued by three LPC devices 44, 45 and 46 are decoded by the second LDRQ control device 38 into DRQ signals, and then these three DRQ signals are taken to participate in the priority arbitration process. The DRQ signal having the highest priority is encoded into LDRQ signal and transferred to the first LDRQ control device 36 as well as the LDRQ signals respectively issued by another three LPC devices 41, 42 and 43. These LDRQ signals received by the first LDRQ control device 36 are decoded into DRQ signals and another priority arbitration process is carried out to resolve the priority to get the mastership of LPC bus 30 for the LPC devices. Hereinafter, the DRQ signal having the highest priority is encoded into a LDRQ signal and transferred to the LDRQ signal pin of the LPC host 60.

Although the present invention has been described and illustrated in detail, it is to be clearly understood that the same is by the way of illustration and example only and is not to be taken by way of limitation, the spirit and scope of the present invention being limited only by the terms of the appended claims.

What is claim is:

1. A method of minimizing the number of LDRQ signal pin of a low pin count bus host, wherein said low pin count bus host is connected in series with at least one LDRQ control device, and said LDRQ device is connected with a plurality of low pin count bus devices and having a LDRQ controller, said method comprises the steps of:
obtaining DRQ signals by decoding LDRQ signals received by said LDRQ control device;
having a priority arbitration process with said DRQ signals and a DRQ signal issued by said LDRQ control device; and
encoding a DRQ signal having a highest priority being resulted from said priority arbitration process into a LDRQ signal, transferring said LDRQ signal to either a LDRQ control device of next stage connected in series therewith or a LDRQ signal pin of said low pin count bus host.

2. The method according to claim 1 wherein said LDRQ controller includes a decoding circuit for decoding a LDRQ signal into a DRQ signal.

3. The method according to claim 1 wherein LDRQ signals received by said LDRQ control device are issued by said plurality of low pin count bus devices.

4. The method according to claim 1 wherein said LDRQ signals received by said LDRQ control device are provided by a LDRQ control device of former stage and said plurality of low pin count bus devices.

5. The method according to claim 1 wherein said priority arbitration process is carried out by a DRQ control circuit.

6. The method according to claim 1 wherein said DRQ signals are used to accomplish either direct memory access transmission or bus master request operation.

7. The method according to claim 1 wherein said priority arbitration process is resolved by relative importance of functionality of said plurality of low pin count bus devices and a DRQ signal issued by said LDRQ control device.

8. The method according to claim 1 wherein said priority arbitration process is resolved by relative importance of functionality of a low pin count bus device that is assigned with a highest priority by the priority arbitration process taken place within a LDRQ control device of former stage, functionality of said plurality of low pin count bus devices and a DRQ signal issued by a LDRQ control device of present stage.

9. The method according to claim 1 wherein said step of encoding a DRQ signal having a highest priority being resulted from said priority arbitration process into a LDRQ signal is accomplished by an encoding circuit.

10. The method according to claim 1 wherein said method is adapted for a LDRQ control device coupled with said LPC host.

11. The method according to claim 1 wherein LDRQ control devices are sequentially connected in series with said low pin count bus host according to the functionality of LDRQ control device.

12. The method according to claim 1 wherein said low pin count bus host is provided with a single LDRQ signal pin.

13. The method according to claim 1 wherein said LDRQ signal and said DRQ signals are present in the form of binary digits.

14. A LDRQ controller for minimizing the number of LDRQ signal pin of a low pin count bus host, with said low pin count bus host is coupled to at least one LDRQ control device, said low pin count bus host is connected with a plurality of low pin count bus devices, said LDRQ controller being incorporated within said LDRQ control device, said LDRQ controller comprising:
a decoding circuit for decoding LDRQ signals into DRQ signals;
a DRQ control circuit used to have a priority arbitration process with received DRQ signals and DRQ signal issued by oneself; and
an encoding circuit for translating received DRQ signals into LDRQ signals and transferring said LDRQ signals to either a LDRQ control device of next stage or a LDRQ signal pin of said low pin count bus host.

15. The LDRQ controller according to claim 14 wherein said decoding circuit is used to translate said LDRQ signals into encoded signals.

16. The LDRQ controller according to claim 14 wherein LDRQ control devices are sequentially connected in series with said low pin count bus host according to the functionality of LDRQ control device.

17. The LDRQ controller according to claim 14 wherein said low pin count bus host is provided with a single LDRQ signal pin.

18. A method of minimizing the number of LDRQ signal pin of a low pin count bus host, said low pin count bus host is connected in series with at least one LDRQ control device, and said LDRQ device is connected with a plurality of low pin count bus devices, said method comprises the steps of:
obtaining DRQ signals by decoding LDRQ signals received by said LDRQ control device;
having a priority arbitration process with said DRQ signals and a DRQ signal issued by said LDRQ control device; and
encoding a DRQ signal having a highest priority being resulted from said priority arbitration process into a LDRQ signal, transferring said LDRQ signal to either a LDRQ control device of next stage connected in series therewith or a LDRQ signal pin of said low pin count bus host.

19. The method according to claim 18 wherein said LDRQ controller includes a decoding circuit for decoding a LDRQ signal into a DRQ signal.

20. The method according to claim 18 wherein LDRQ signals received by said LDRQ control device are issued by said plurality of low pin count bus devices.

21. The method according to claim 18 wherein said LDRQ signals received by said LDRQ control device are provided by a LDRQ control device of former stage and said plurality of low pin count bus devices.

22. The method according to claim 18 wherein said priority arbitration process is carried out by a DRQ control circuit.

23. The method according to claim 18 wherein said DRQ signals are used to accomplish either direct memory access transmission or bus master request operation.

24. The method according to claim 18 wherein said priority arbitration process is resolved by relative importance of functionality of said plurality of low pin count bus devices.

25. The method according to claim 18 wherein said priority arbitration process is resolved by relative importance of functionality of a low pin count bus device that is assigned with a highest priority by the priority arbitration process taken place within a LDRQ control device of former stage, functionality of said plurality of low pin count bus devices and a DRQ signal issued by a LDRQ control device of present stage.

26. The method according to claim 18 wherein said step of encoding a DRQ signal having a highest priority being resulted from said priority arbitration process into a LDRQ signal is accomplished by an encoding circuit.

27. The method according to claim 18 wherein said method is adapted for a LDRQ control device coupled with said LPC host.

28. The method according to claim 18 wherein said low pin count bus host is provided with a single LDRQ signal pin.

29. The method according to claim 18 wherein said LDRQ signal and said DRQ signals are present in the form of binary digits.
